(19) United States
(12) Patent Application Publication
(10) Pub. No.: US 2011/0025195 A1
(43) Pub. Date: Feb. 3, 2011

(54) Clothing with Removable Electroluminescent Panels

(76) Inventor: Dhevsivanand Govender, Tampa, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/510,764

(22) Filed: Jul. 28, 2009

(51) Int. Cl. H01J 1/63; F21V 21/08; F21V 9/16

(52) U.S. Cl. 313/504; 362/103; 362/84

(57) ABSTRACT

Disclosed is a system for illuminating clothing. The invention includes a T-shirt with an electroluminescent panel that is removably secured by way of hook and pile fasteners, such as velcro® fasteners. The panel is coupled to a removable battery pack stored within the T-shirt. The garment can be machine washed by easily removing both the panel and the battery pack.

### BACKGROUND OF THE INVENTION

1. Field of the Invention

This invention relates to illuminated clothing. More particularly, the present invention relates to clothing that incorporates one or more removable electroluminescent panels and an associated power source.

2. Description of the Background Art

The decorative illumination of clothing is known in the art. These efforts generally involve incorporating discrete illumination sources, such as light bulbs or light emitting diodes, into hats or T-shirts. The light sources are typically powered by a power source incorporated into the clothing. Visual effects can be achieved by choosing different colored lights and/or the use of flashing lights. The lights can also be incorporated into screen printed logos or designs on the clothing.

It is also known in the art to use an electroluminescent circuit with a garment. Such an electroluminescent circuit is disclosed in U.S. Pat. No. 6,116,745 to Yei. Yei discloses an illuminated display panel for a garment including a circuit with an electrical microchip, a plurality of resistors, a plurality of rectifiers and an electroluminescent display element. The circuit is powered by a non-rechargeable battery.

Although these prior efforts generally produce pleasing results, they also suffer from considerable drawbacks. One such drawback involves the use of a battery pack. Namely, prior efforts have utilized complicated and cumbersome means of incorporating the power pack into the clothing. This, in turn, leads to difficulties in separating the power pack from the clothing prior to washing the clothing. Moreover, the illuminated clothing of the prior art utilizes power packs with a limited duration and that are difficult to recharge, thereby severely limiting the use of such clothing.

Prior examples of illuminated clothing also suffered from drawbacks inherent in the use of discrete illumination sources. For instance, discrete illumination sources cannot be used to uniformly illuminate a logo or display and otherwise provide a less pleasing visual effect. Discrete illumination sources are also more prone to damage via contact and or routine use.

### SUMMARY OF THE INVENTION

It is therefore one of the objectives of this invention to illuminate clothing via non discrete illumination sources.

It is an additional object of the present invention to provide clothing that is illuminated by way of a phosphorous layer that is activated by a current source.

It is another object of this invention to provide clothing that is illuminated via one or more flexible electroluminescent panels.

It is another object of this invention to provide an easily removable and rechargeable power pack for use with illuminated clothing.

Still yet another object of this invention is to provide a system wherein clothing can be readily decorated by a variety of removable illuminated panels, with each panel having a different logo design and color.

These and other objects are achieved by providing a system that includes a garment with a panel and a first fastener. The system also includes a battery that is secured to the garment and a button for selectively activating and deactivating the battery. A flexible electroluminescent device, comprising a phosphorous layer sandwiched between opposing electrodes, forms yet another component of the system. An electrical connector serves to connect the electrodes to the battery. A second fastener is associated with the electroluminescent device. The electroluminescent device includes a front face with a logo that can be illuminated by the phosphorous layer. The first and second connectors of the system are used to removably secure the electroluminescent device to the panel of the garment.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a front elevational view of the clothing and the associated electroluminescent panel of the present invention.

FIG. 2 is a front elevational view of the illuminated clothing with the electroluminescent panel being removed.

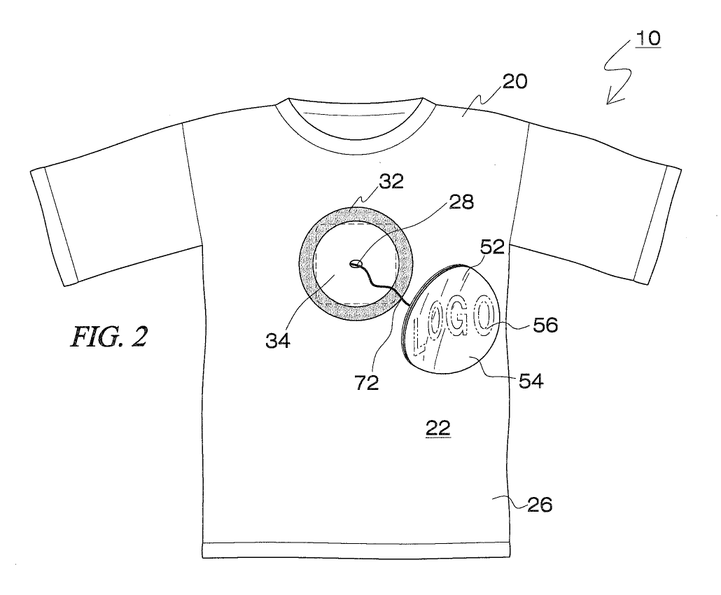

FIG. 3 is a detailed view of the rechargeable battery pack and the removable electroluminescent panel.

FIG. 4 is a sectional view taken along line 4-4 of FIG. 1.

FIG. 5 is an exploded view of the illuminated clothing of the present invention.

FIG. 6 is a sectional view of the electroluminescent panel of the present invention.

Similar reference characters refer to similar parts throughout the several views of the drawings.

### DETAILED DESCRIPTION OF THE PREFERRED EMBODIMENT

The present invention relates to illuminated clothing. In the preferred embodiment, the invention includes a T-shirt with an electroluminescent panel that is removably secured by way of hook and pile fasteners, such as velcro® fasteners. The panel is coupled to a removable battery pack stored within the T-shirt. The garment can be machine washed by easily removing both the panel and the battery pack. The various features of the present invention, and the manner in which they interrelate, are described in greater detail hereinafter.

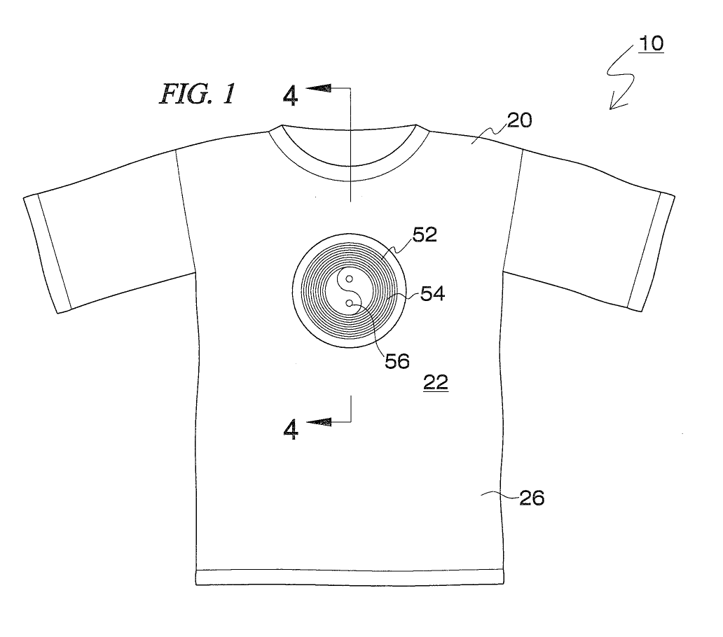

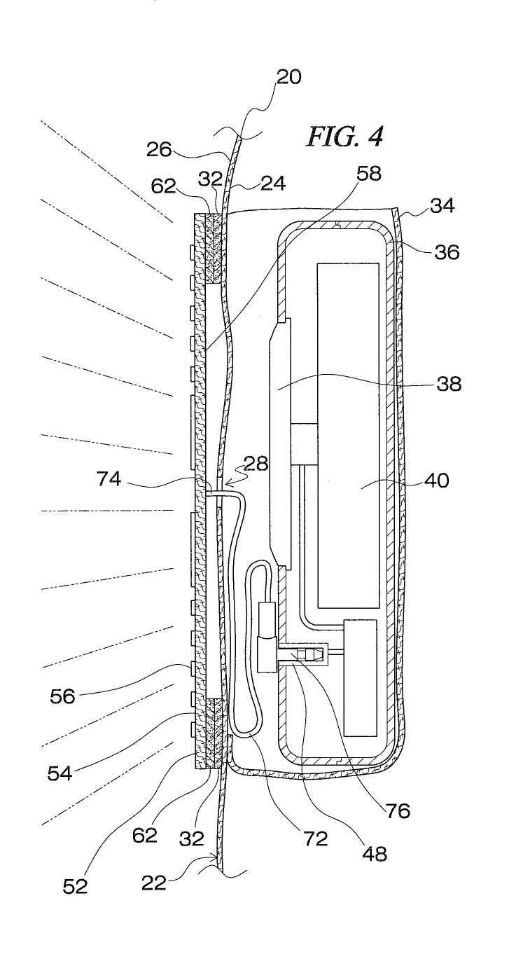

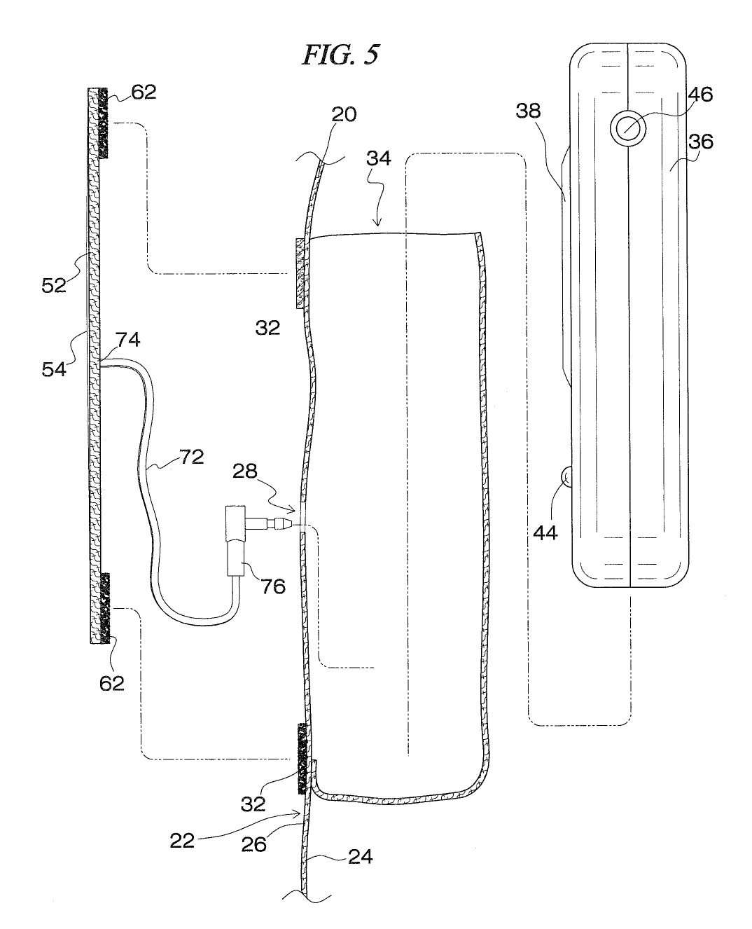

With reference to FIG. 1, the system 10 of the present invention is depicted. The system 10 utilizes a T-shirt 20, which is preferably a conventional machine washable cotton shirt with a front panel 22 and a back panel and interior and exterior surfaces (24 and 26). In order to accommodate the electroluminescent panel 52 of the present invention, T-shirt 20 has a small opening 28 formed through front panel 22. In the depicted embodiment, opening 28 is centrally located on the chest of T-shirt 20. However, opening 28 can be placed in other locations to accommodate different locations for electroluminescent panel 52. With reference now to FIGS. 4 and 5, it can be seen that a pocket 34 is sewn on to the interior surface of front panel 22. Pocket 34 can optionally include a removable cover. Pocket 34 is preferably large enough to hold a battery pack 36 in a manner described more fully hereinafter. With continuing reference to FIGS. 4 and 5, it is noted that pocket 34 is ideally sewn at a location such that it is centered about opening 28. In this manner opening 28 is easily accessible from the interior of pocket 34. Although the invention is depicted as being employed in conjunction with T-shirt 20 it can likewise be utilized in association with a wide variety of other garments, such as sweaters, hats, pants, jackets, and gloves. The invention can likewise be employed with other items such as camping gear, backpacks, and tote bags. The only requirement is that the garment have a generally flat surface to receive the electroluminescent panel 52 and pocket 34.

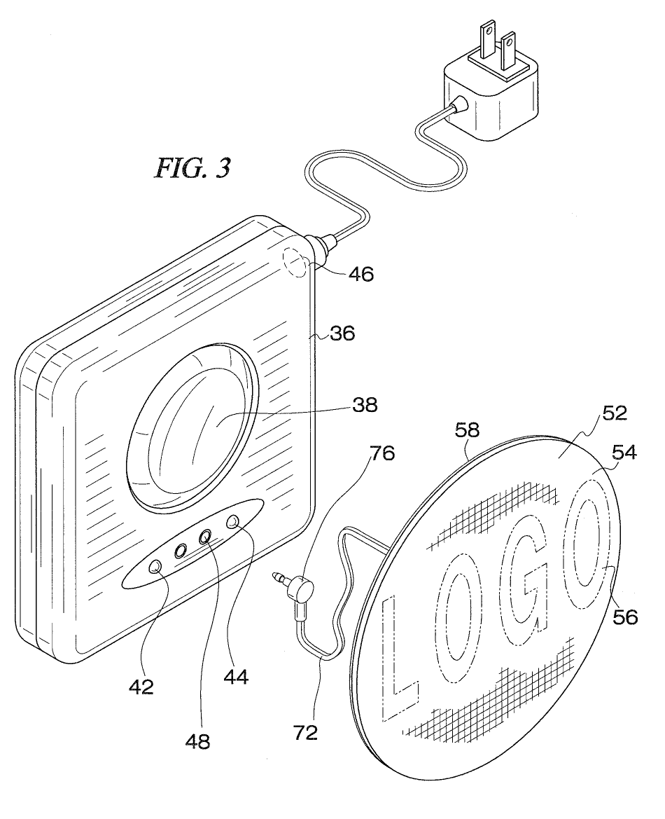

Battery pack 36 is next described in conjunction with FIGS. 3-5. Battery pack 36 is formed from a clam-shell type housing formed from an impact resistant plastic. Pack 36 houses a rechargeable battery 40 such as a lithium ion battery. Although the invention is described in conjunction with rechargeable batteries, nonrechargeable batteries, such as alkaline batteries, can also be used. The pack also houses the circuitry associated with the power source. Circuitry for operating the panel can likewise be stored in the battery pack.

As indicated in FIG. 3, the outer face of battery pack 36 includes an enlarged and centrally located button 38 for activating and/or deactivating the power supply. This allows a user to selectively turn on and off the electroluminescent panel 52 in a manner described more fully hereinafter. Battery pack 36 further includes a series of LED indicators (42 and 44). In the depicted embodiment, one indicator 42 signals when the battery is charging and a separate indicator 44 signals when the device is fully charged. FIGS. 3 and 5 further illustrate how battery pack 36 can be coupled to an external power source by way of a conventional USB port 46 and an associated power cable. This enables battery 40 to be charged either from a computer or a wall outlet. Battery pack 36 further includes a female electrical connector 40 (FIG. 3) that is adapted to receive an associated one or two prong connector from the electroluminescent panel.

In the depicted embodiment, electroluminescent panel 52 includes a front surface 54 with circular “ying and yang” symbol 56. The variety of logos and designs that can be incorporated into the panel are endless. Whatever design is employed, panel 52 includes a back side 62 with hook and pile fasteners 62 that permit it to be removably secured to an associated garment. The use of other equivalent fastening mechanism is within the scope of the present invention.

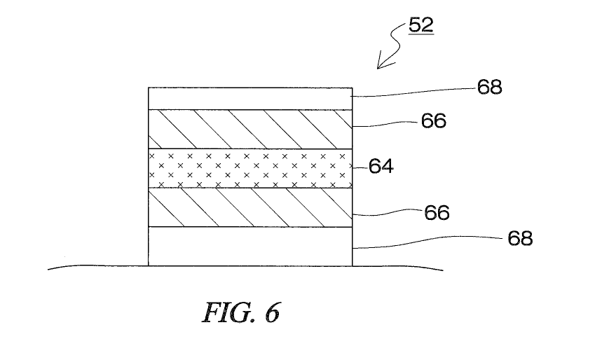

Electroluminescent panels 52 provide a unique glowing effect while at the same time being both flexible and lightweight. They likewise consume little power, thereby decreasing the size of the associated power source. Electroluminescent panels are known in the art and a suitable device is described in U.S. Pat. No. 5,605,217 to Kang. The contents of this patent are hereby incorporated by reference. The general structure of a suitable electroluminescent panel 52 is illustrated in the cross-sectional view of FIG. 6. Namely, the device includes an intermediate phosphorous layer 64 that is sandwiched between upper and lower insulating layers 66 and upper and lower electrodes 68. The lower most electrode 68, as is known in the art, can be formed from a transparent conductive layer of indium tin oxide (ITO). Moreover, electrodes 68 are coupled to battery 40 to provide a electric current to the phosphorous layer 64. The phosphorous material responds to the electrical current by glowing. Depending upon the specific phosphorus material used, a variety of colors can be generated. Moreover, the resulting light source is diffused over the entire panel 52. In accordance with the invention, the phosphorous material is used to directly illuminate the associated logo or design, thereby eliminating the need for a stencil. Moreover, in contrast to illumination sources with discreet components such as incandescent light bulbs or light emitting diodes.

With reference now to FIGS. 3 and 5, it can be seen that the electroluminescent panel 52 is coupled to the battery pack 36 via a power cable 72. This cabling 72 has a proximal end 72 in contact with electrodes 68 and a distal end with a male connector 76. Male connector 76 can have either a single or a dual prong. With the battery pack 36 stored within pocket 34, cabling 72 can be routed through opening 28 in front panel 22 of T-shirt 20 and coupled to female connector 48 of the battery pack 36. Provided that battery pack 36 is properly charged, an electrical circuit is established between battery pack 36 and electroluminescent panel 52. Thereafter, the user can activate the electroluminescent panel 52 by pressing the panel 52, and in turn, button 38 on the battery pack 36 to power and illuminate the panel 52. Additional circuitry can be included in the event differing effects are desired. Namely, circuitry can be included for the cyclic or intermittent illumination of the panel 52.

As will be appreciated, if the user wishes to display a different logo or design, the electroluminescent panel 52 can be easily replaced by way of the hook and pile fasteners 36 and 62. Additionally, once the battery 40 is depleted battery pack 36 can be removed from pocket 34 and recharged via a wall outlet or from a personal computer via a USB port. Additionally, by removing both battery pack 36 and the illumination panel 52 the T-shirt 20 can be washed via a conventional washer.

What is claimed is:

1. A system for illuminating clothing comprising in combination:
a t-shirt formed from a machine washable cotton, the t-shirt having a front panel with interior and exterior surfaces, a centrally positioned opening formed through the front panel, a circular band of a hook and pile fastener positioned about the opening upon the exterior surface, a pocket sewn to the interior surface, the opening being accessible from the pocket;
a battery pack including a rechargeable lithium-ion battery, the battery pack including a button for selectively activating and deactivating the battery, indicators for providing a visual indication when the battery is charging and when the battery is fully charged, a USB port for coupling the battery to an external power supply and a female connector, the batter pack positioned within the pocket;
an electroluminescent device having a front side and a back side, hook and pile fasteners formed upon the back side, a logo formed upon the front side, cabling including a first end secured to the electroluminescent device and a second end comprising a male connector, whereby the electroluminescent device is removably secured to the front panel of the t-shirt via the hook and pile fasteners, and wherein the cabling is routed through the opening in the T-shirt and coupled to the female connector of the battery pack to thereby power the electroluminescent device.

2. A system for illuminating clothing comprising in combination:
a garment having a front panel with interior and exterior surfaces, an opening formed through the front panel, a first fastener positioned adjacent the opening upon the exterior surface;
a battery pack including a battery secured to the garment, the battery pack including a button for selectively activating and deactivating the battery, and a female connector;
an electroluminescent device having a front side and a back side, a second fastener formed upon the back side, a logo formed upon the front side, cabling including a first end secured to the electroluminescent device and a second end comprising a male connector, whereby the electroluminescent device is removably secured to the front panel of the garment via the first and second fasteners, and wherein the cabling is routed through the opening in the garment and coupled to the female connector of the battery pack to thereby power the electroluminescent device.

3. The system as described in claim 2 wherein a pocket is sewn to the interior surface of the garment and wherein the battery pack is positioned within the pocket.

4. The system as described in claim 2 wherein the electroluminescent device is a panel comprising a phosphorous layer sandwiched between opposing insulators and electrodes.

5. The system as described in claim 2 wherein the first and second fasteners are hook and pile type fasteners.

6. The system as described in claim 2 wherein the electroluminescent device and the battery pack can be completely removed to facilitate washing of the garment.

7. A system for illuminating clothing comprising in combination:
a garment having a panel and a first fastener;
a battery secured to the garment and a button for selectively activating and deactivating the battery;
an electroluminescent device comprising a phosphorous layer sandwiched between opposing electrodes, an electrical connector connecting the electrodes to the battery, a second fastener associated with the electroluminescent device, the electroluminescent device having a front face with a logo that can be illuminated by the phosphorous layer, wherein the first and second connectors are used to removably secure the electroluminescent device to the panel of the garment.

8. The system as described in claim 7 wherein the phosphorous layer is chosen so as to exhibit a specified color when exposed to a current source.

9. The system as described in claim 7 wherein the electroluminescent device is a flexible panel.
